(19) United States
(12) Patent Application Publication
(10) Pub. No.: US 2014/0070998 A1
(43) Pub. Date: Mar. 13, 2014

(54) DEVICE AND METHOD FOR RECOGNIZING LOCATION BY CONVERSION OF FREQUENCY OFFSET

(71) Applicant: Electronics and Telecommunications Reasearch Institute, Daejeon (KR)

(72) Inventors: Woo Yong LEE, Daejeon (KR); Jin Kyeong KIM, Daejeon (KR)

(73) Assignee: Electronics and Telecommunications Reasearch Institute, Daejeon (KR)

(21) Appl. No.: 14/021,163

(22) Filed: Sep. 9, 2013

(30) Foreign Application Priority Data
Sep. 10, 2012 (KR) 10-2012-0099812
Aug. 22, 2013 (KR) 10-2013-0099800

(51) Int. Cl. G01S 5/10

(52) U.S. Cl. CPC G01S 5/10
USPC 342/464

(57) ABSTRACT

Provided is an apparatus and method for recognizing a location by conversion of a frequency offset, the apparatus including a setting unit to receive, from a terminal, a plurality of signals comprising a first signal and a second signal, and to set a variable corresponding to each of the plurality of signals, a detector to detect a first residual phase of a carrier frequency of the first signal and a second residual phase of a carrier frequency of the second signal using the variables, and a recognizer to recognize a location of the terminal by calculating a difference between the first residual phase and the second residual phase.

### CROSS-REFERENCE TO RELATED APPLICATIONS

This application claims the priority benefit of Korean Patent Application No. 10-2012-0099812, filed on Sep. 10, 2012, and Korean Patent Application No. 10-2013-0099800, filed on Aug. 22, 2013, in the Korean Intellectual Property Office, the disclosures of which are incorporated herein by reference.

### BACKGROUND

1. Field of the Invention

Embodiments of the present invention relate to a technology of receiving a plurality of signals from a terminal, detecting a residual phase of a carrier frequency of each of the plurality of signals as a frequency offset, and recognizing a location of the terminal using a residual phase difference in a wireless sensor network and a machine to machine (M2M) communication field.

2. Description of the Related Art

In a wireless local area network (WLAN) environment, such as Institute of Electrical and Electronics Engineers (IEEE) 802.11 of and IEEE 802.11ah, a variety of methods including a radio signal strength indication (RSSI) method, a time of arrival (TOA) method, a time difference of arrival (TDOA) method, and an angle of arrival (AOA) are used to detect and recognize a location of a terminal. The above methods may recognize the location of the terminal by measuring an angle, a transmission time, and a strength of a signal transmitted from the terminal. However, the above methods may require an accurate field of view and repeating of a signal transfer process. In addition, due to use of an array antenna in order to detect the angle of the single, an amount of calculation may significantly increase.

Accordingly, there is a need for a technology that may more efficiently and accurately recognize a location of a terminal by analyzing a frequency of a signal received from the terminal, instead of measuring an angle, a transmission time, and a strength of the signal.

### SUMMARY

An aspect of the present invention is to measure a distance from a terminal using frequency offsets of a plurality of signals in a wireless local area network (WLAN) environment.

Another aspect of the present invention is to recognize a location of a terminal present in a remote distance by analyzing a frequency of a signal instead of measuring a transmission time of a plurality of signals.

According to an aspect of the present invention, there is provided a location recognition apparatus including a setting unit to receive, from a terminal, a plurality of signals including a first signal and a second signal, and to set a variable corresponding to each of the plurality of signals, a detector to detect a first residual phase of a carrier frequency of the first signal and a second residual phase of a carrier frequency of the second signal using the variables, and a recognizer to recognize a location of the terminal by calculating a difference between the first residual phase and the second residual phase.

According to another aspect of the present invention, there is provided a location recognition method including receiving, from a terminal, a plurality of signals including a first signal and a second signal, and setting a variable corresponding to each of the plurality of signals, detecting a first residual phase of a carrier frequency of the first signal and a second residual phase of a carrier frequency of the second signal using the variable, and recognizing a location of the terminal by calculating a difference between the first residual phase and the second residual phase.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram to describe a configuration of a location recognition apparatus according to an embodiment of the present invention;

FIG. 2 is a block diagram illustrating a configuration of a location recognition apparatus according to an embodiment of the present invention;

FIG. 3 is a diagram to describe an example of recognizing a location of a terminal according to an embodiment of the present invention; and

FIG. 4 is a flowchart illustrating a location recognition method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

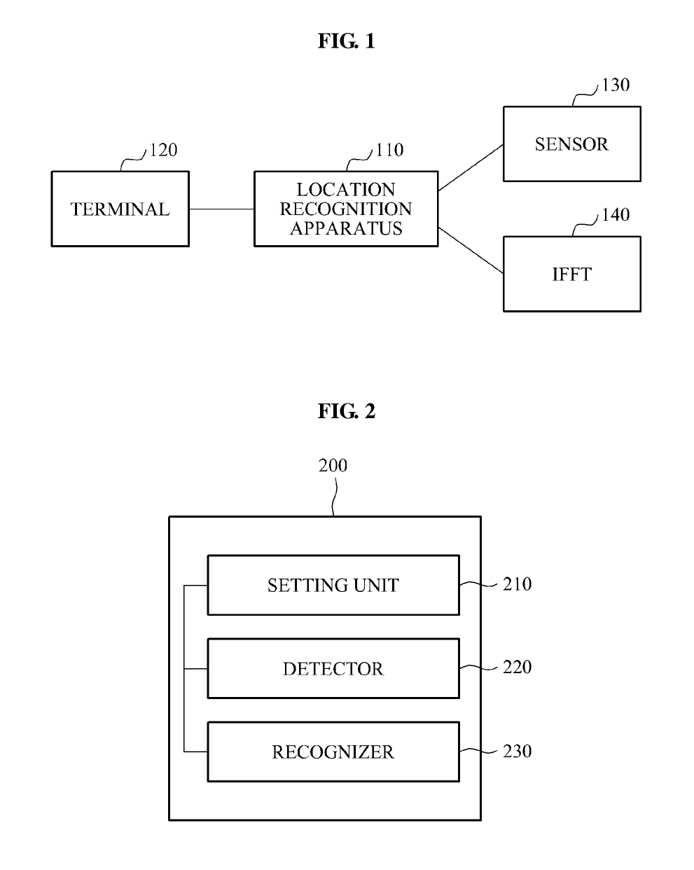

FIG. 1 is a block diagram to describe a configuration of a location recognition apparatus 110 according to an embodiment of the present invention.

Referring to FIG. 1, the location recognition apparatus 110 may receive a plurality of signals from a terminal 120, and may recognize a location of the terminal 120 using frequency offsets of the plurality of signals. A frequency offset may indicate a difference between a frequency occupied by a signal transmitted from the terminal 120 and a signal received by the location recognition apparatus 110. A radio station configured to transfer a signal of the terminal 120 to the location recognition apparatus 110 may modulate a frequency of the terminal 120 to a predetermined frequency in order to further transfer the signal without causing an error. For example, the radio station may modulate the frequency to a carrier frequency of a high frequency. The location recognition apparatus 110 may receive a signal transmitted from the terminal 120 and may detect a frequency offset using a carrier frequency.

The location recognition apparatus 110 may be connected to a plurality of sensors 130 constituting a wireless sensor network to receive a plurality of signals from the terminal 120. The plurality of sensors 130 may sense the plurality of signals at different locations and then convert the sensed signals to electrical signals and transfer the converted signals to the location recognition apparatus 110. The location recognition apparatus 110 may separate a frequency from each signal, and may obtain a frequency offset. The location recognition apparatus 110 may separate a predetermined frequency signal from a signal using an inverse fast Fourier transformer (IFFT) 140, may obtain a residual phase of the frequency, and may obtain the frequency offset. The IFFT 140 may receive the plurality of signals, and may generate a frequency distribution according to a change in a time.

The location recognition apparatus 110 may recognize the location of the terminal 120 by calculating a frequency offset difference between the plurality of signals as a distance. For example, the location recognition apparatus 110 may calculate the distance by detecting a residual phase from among frequency offset components.

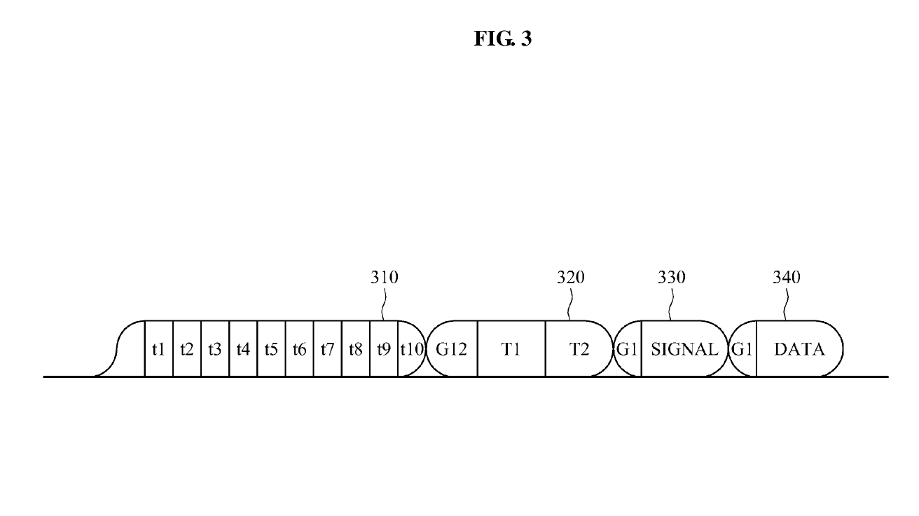

FIG. 2 is a block diagram illustrating a configuration of a location recognition apparatus 200 according to an embodiment of the present invention.

Referring to FIG. 2, the location recognition apparatus 200 may include a setting unit 210, a detector 220, and a recognizer 230.

The setting unit 210 may receive, from a terminal, a plurality of signals including a first signal and a second signal, and may set a variable corresponding to each of the plurality of signals. The variable may be associated with a characteristic of a signal and a characteristic of a frequency used to load and transfer the signal. The setting unit 210 may define the signal as a mathematical function using the variable, and may predict a value of the variable.

The setting unit 210 may receive the plurality of signals using a plurality of sensors configured to sense the plurality of signals at different locations, and may set, as the variable, at least one of a transmission distance, a transmission time, and a velocity of light with respect to the plurality of signals. The setting unit 210 may set the variable so that the transmission time is greater than a value obtained by dividing the transmission distance by the velocity of light.

The setting unit 210 may receive the plurality of signals using a television white space (TVWS) frequency. The TVWS frequency may indicate a frequency that is not locally used. Due to a propagation characteristic, the TVWS frequency may have relatively wide service coverage compared to a frequency of 1 GHz or more and thus, may be widely utilized.

The detector 220 may detect a first residual phase of a carrier frequency of the first signal and a second residual phase of a carrier frequency of the second signal using the variables. The carrier frequency may indicate a frequency used to load and transfer a signal. The detector 220 may detect a residual phase by applying the variable to a relational formula between a random phase offset of the carrier frequency and a phase offset of a reference frequency that is generated when the signals having carrier frequency is transmitted. When the plurality of signals having the same carrier frequency is simultaneously transmitted from the same terminal, the detector 220 may exclude the random phase offset from the relational formula.

The detector 220 may utilize information associated with the carrier frequency, extracted based on a preamble structure of each of the first signal and the second signal, to detect a residual phase. A preamble may include a short training symbol and a long training symbol, and be used to transfer information for time synchronization and frequency synchronization.

The recognizer 230 may recognize a location of the terminal by calculating a difference between the first residual phase and the second residual phase. The recognizer 230 may express a distance from the terminal through the difference between the first residual phase and the second residual phase, and may recognize the location of the terminal using a distance having a relatively maximum value from the expressed distance. Here, when the difference between the first residual phase and the second residual phase is less than a periodic value of the carrier frequency, the recognizer 230 may recognize the location of the terminal.

When the plurality of signals is received from different terminals, the recognizer 230 may recognize the location of the terminal by further using a distance between the terminals. The recognizer 230 may calculate a pseudo range from the terminal by multiplying a transmission time of each of the plurality of signals by a velocity of light thereof, and may predict an actual distance from the terminal based on the pseudo range. The pseudo range may include a propagation delay and an error by a field of view.

FIG. 3 is a diagram to describe an example of recognizing a location of a terminal according to an embodiment of the present invention.

A location recognition apparatus may receive a signal 330 from the terminal based on a preamble defined in a wireless local area network (WLAN) environment, and may perform communication. The location recognition apparatus may extract information associated with a carrier frequency from the signal 330 based on a structure of the preamble transmitted together with the signal 330, and may detect a residual phase.

The preamble may include a short training symbol 310 and a long training symbol 320. The location recognition apparatus may achieve time synchronization and frequency synchronization with the terminal through the short training symbol 310 and the long training symbol 320.

The short training symbol 310 may include ten symbols t1, t2, t3, t4, t5, t6, t7, t8, t9, and t10 in association with signal detection, automatic gain control (AGC), diversity selection, minute time synchronization, and integer fold frequency error estimation. The long training symbol 320 may include two symbols T1 and T2 in association with channel estimation and minority fold frequency error estimation. The location recognition apparatus may predict an approximate frequency offset from the short training symbol 310 and may predict a further precise frequency offset from the long training symbol 320.

The location recognition apparatus may receive the signal 330 indicating a length of data and a transmission rate, which is transmitted successive to the short training symbol 310 and the long training symbol 320. The transmission rate may have a transmission rate value supported in a WLAN.

The location recognition apparatus may determine a modulation scheme and a demodulation scheme with respect to the signal 330. The location recognition apparatus may determine that the signal 330 is errorlessly received through checking a parity bit of the signal 330, and may perform demodulation using a decoder. The location recognition apparatus may receive data 340 successive to the signal 330. The data 340 may include PSDU, SERVICE, TAIL bits, and PAD bit.

When transmission of the data 340 is completed, the location recognition apparatus may detect a frequency offset with respect to a first signal r₁(t, d) and a second signal r₂(t, d).

The location recognition apparatus may set a variable corresponding to each of the first signal r₁(t, d) and the second signal r₂(t, d) and thereby express the same as shown in Equation 1.

r₁(t,d)=e^{j ω̅}^{₁}^{(t-d/c)}+φ₁−θ,ω₁=2πf₁

r₂(t,d)=e^{j ω̅}^{₂}^{(t-d/c)}+φ₂−θ,ω₂=2πf₂ [Equation 1]

In Equation 1, φ1 and φ2 denote random phase offsets of two carrier frequencies, respectively, and θ denotes a phase offset of a receiver clock, for example, a local oscillator. Equation 1 may be a relational formula between a random phase offset and a phase offset. The recognition apparatus may set variables by setting “d” as a transmission distance, setting “c” as a velocity of light, and setting “t” as a transmission time, and may apply the set variables to Equation 1. In this example, the location recognition apparatus may set the variables so that the transmission time may be greater than a value obtained by the transmission distance by the velocity of light. That is, the location recognition apparatus may set the variables to satisfy t>d/c.

The location recognition apparatus may assume a distance from the terminal as “d₁” in Equation 1, and may obtain a first residual phase Θ₁ of a carrier frequency of the first signal and a second residual phase Θ₂ of a carrier frequency of the second signal according to

$$\begin{matrix}Equation 2 & \\ {Θ}_{1} = 2 π {f}_{1} \frac{{d}_{1}}{c} + {φ}_{1} - θ \\ {Θ}_{2} = 2 π {f}_{2} \frac{{d}_{1}}{c} + {φ}_{2} - θ & [ Equation 2 ]\end{matrix}$$

The location recognition apparatus may obtain a difference between the first residual phase and the second residual distance according to Equation 3.

$${Θ}_{1} - {Θ}_{2} = 2 π ( {f}_{2} - {f}_{1} ) \frac{{d}_{1}}{c} + ( {φ}_{1} - {φ}_{2} ) \qquad [ Equation 3 ]$$

The random phase offset frequency (φ₁-φ₂) of carrier frequencies may be ignored when corresponding signals are simultaneously transmitted from the same terminal. The location recognition apparatus may calculate the distance from the terminal through the difference between the carrier frequencies (f₂−f₁) and the difference between the first residual phase and the second residual phase (Θ₁−Θ₂).

The distance d₁ from the terminal may be calculated according to Equation 4.

$${d}_{1} = \frac{c ( {Θ}_{1} - {Θ}_{2} )}{2 π ( {f}_{2} - {f}_{1} )} \qquad [ Equation 4 ]$$

The location recognition apparatus may express the distance from the terminal through the difference between the first residual phase and the second residual phase, may obtain a distance having a relatively maximum value from the expressed distance according to Equation 5, and thereby recognize the location of the terminal.

When the difference between the first residual phase and the second residual phase is less than a periodic value of the carrier frequency, for example, when |Θ₁−Θ₂|≦2π is satisfied, the location recognition apparatus may recognize the location of the terminal. The location recognition apparatus may measure the distance from the terminal by a distance corresponding to the difference between the carrier frequencies (f₂−f₁).

$${d}_{max} = \frac{c}{{f}_{2} - {f}_{1}} \qquad [ Equation 5 ]$$

For example, if f₁ is 50 MHz and f₂ is 56 MHz, (f₂−f₁) becomes 6 MHz. With respect to the carrier frequency 6 MHz, the location recognition apparatus may measure the distance from the terminals up to a maximum of 3.2 km as shown in Table 1.

TABLE 1

| Use frequency | Maximum recognizable |
|---|---|
| bandwidth (MHz) | distance dₘₐₓ (Km) |
| 0.5 | 38.4 |
| 1 | 19.2 |
| 2 | 9.6 |
| 4 | 4.8 |
| 6 | 3.2 |
| 20 | 0.96 |

Table 1 shows a maximum recognizable distance using a residual phase difference between a plurality of signals.

Referring to Table 1, a maximum measurable distance using a carrier frequency decreases according to an increase in a carrier frequency. When a terminal is located in a remoter distance compared to the maximum measurable distance, accuracy in measuring the distance may decrease.

The location recognition apparatus may select one of carrier frequencies of the first signal and the second signal, and may measure a distance using the selected carrier frequency, thereby enhancing the accuracy. When the first signal and the second signal are received from different terminals, the location recognition apparatus may recognize the location of the terminal based on a distance between the terminals.

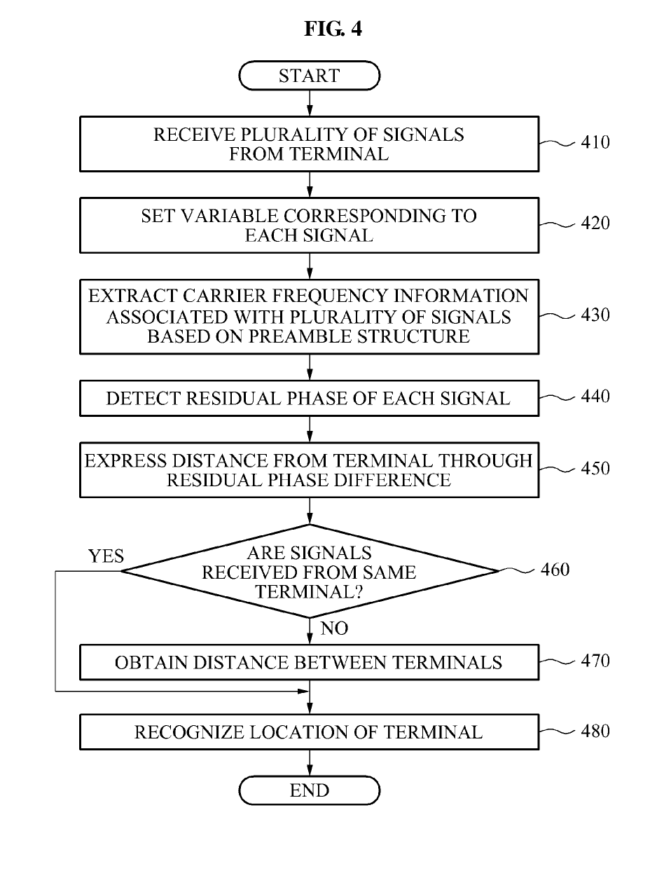

FIG. 4 is a flowchart illustrating a location recognition method according to an embodiment of the present invention.

Referring to FIG. 4, a location recognition apparatus may receive a plurality of signals from a terminal in operation 410, and may set a variable corresponding to each of the plurality of signals in operation 420. The variable may be associated with a characteristic of a signal and a characteristic of a frequency used to load and transfer the signal. The location recognition apparatus may define the signal as a mathematical function using the variable, and may predict a value of the variable. The location recognition apparatus may receive the plurality of signals using a plurality of sensors configured to sense the plurality of signals at different locations, and may set, as the variable, at least one of a transmission distance, a transmission time, and a velocity of light with respect to the plurality of signals. The location recognition apparatus may set the variable so that the transmission time is greater than a value obtained by dividing the transmission distance by the velocity of light.

In operation 430, the location recognition apparatus may extract carrier frequency information associated with the plurality of signals based on a preamble structure of each of the plurality of signals. A preamble may include a short training symbol and a long training symbol, and be used to transfer information for time synchronization and frequency synchronization.

In operation 440, the location recognition apparatus may detect a residual phase of a carrier frequency of each of the plurality of signals using the carrier frequency information and the variable. The carrier frequency may indicate a frequency used to load and transfer a signal. The location recognition apparatus may detect the residual phase by applying the variable to a relational formula between a random phase offset of the carrier frequency and a phase offset of a reference frequency that is generated when the signals having carrier frequency is transmitted. When the plurality of signals having the same carrier frequency is simultaneously transmitted from the same terminal, the location recognition apparatus may detect the residual phase by excluding the random phase offset from the relational formula.

In operation 450, the location recognition apparatus may express a distance from the terminal through the residual phase difference. The location recognition apparatus may use a distance having a relatively maximum value from the expressed distance. Here, when the residual phase difference is less than a periodic value of the carrier frequency, the location recognition apparatus may recognize the location of the terminal.

In operation 460, the location recognition apparatus may determine whether the plurality of signals is transmitted from the same terminal. When the plurality of signals is transmitted from different terminals, the location recognition apparatus may obtain a distance between the terminals in operation 470 and may recognize the location of the terminal by further using the distance between the terminals in operation 480.

The location recognition apparatus may calculate a pseudo range from the terminal by multiplying a transmission time of each of the plurality of signals by a velocity of light thereof, and may predict an actual distance from the terminal based on the pseudo range.

According to embodiments of the present invention, it is possible to recognize an accurate location of a terminal by receiving a plurality of signals from the terminal, analyzing a frequency of each signal instead of measuring a transmission time thereof, and thereby decreasing dependency on an accurate field of view.

Also, according to embodiments of the present invention, it is possible to measure a distance from a terminal by calculating a residual phase of a carrier frequency of each of a plurality of signals, and to recognize a location of the terminal even in a remote distance using the measured distance.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for recognizing a location by conversion of a frequency offset, the apparatus comprising:
a setting unit to receive, from a terminal, a plurality of signals comprising a first signal and a second signal, and to set a variable corresponding to each of the plurality of signals;
a detector to detect a first residual phase of a carrier frequency of the first signal and a second residual phase of a carrier frequency of the second signal using the variables; and
a recognizer to recognize a location of the terminal by calculating a difference to between the first residual phase and the second residual phase.

2. The apparatus of claim 1, wherein the setting unit sets, as the variable, at least one of a transmission distance, a transmission time, and a velocity of light with respect to the plurality of signals.

3. The apparatus of claim 1, wherein the setting unit sets the variable so that a transmission time is greater than a value obtained by dividing a transmission distance by a velocity of light with respect to the plurality of signals.

4. The apparatus of claim 1, wherein the detector utilizes information associated with the carrier frequency, extracted based on a preamble structure of each of the first signal and the second signal, to detect a residual phase.

5. The apparatus of claim 1, wherein the detector detects a residual phase by applying the variable to a relational formula between a random phase offset of the carrier frequency and a phase offset of a reference frequency that is generated when signals having the carrier frequency is transmitted.

6. The apparatus of claim 5, wherein when the plurality of signals having the same carrier frequency is simultaneously transmitted from the same terminal, the detector detects the residual phase by excluding the random phase offset from the relational formula.

7. The apparatus of claim 1, wherein the recognizer expresses a distance from the terminal through the difference between the first residual phase and the second residual phase, and recognizes the location of the terminal using a distance having a relatively to maximum value from the expressed distance.

8. The apparatus of claim 1, wherein when the difference between the first residual phase and the second residual phase is less than a periodic value of the carrier frequency, the recognizer recognizes the location of the terminal.

9. The apparatus of claim 1, wherein when the plurality of signals is received from different terminals, the recognizer recognizes the location of the terminal by further using a distance between the terminals.

10. The apparatus of claim 1, wherein the setting unit receives the plurality of signals using a television white space (TVWS) frequency.

11. A method of recognizing a location by conversion of a frequency offset, the method comprising:
receiving, from a terminal, a plurality of signals comprising a first signal and a second signal, and setting a variable corresponding to each of the plurality of signals;
detecting a first residual phase of a carrier frequency of the first signal and a second residual phase of a carrier frequency of the second signal using the variable; and
recognizing a location of the terminal by calculating a difference between the first residual phase and the second residual phase.

12. The method of claim 11, wherein the setting comprises setting, as the variable, at least one of a transmission distance, a transmission time, and a velocity of light with respect to the plurality of signals.

13. The method of claim 11, wherein the setting comprises setting the variable so that a transmission time is greater than a value obtained by dividing a transmission distance by a velocity of light with respect to the plurality of signals.

14. The method of claim 11, further comprising:
utilizing information associated with the carrier frequency, extracted based on a preamble structure of each of the first signal and the second signal, to detect a residual phase.

15. The method of claim 11, wherein the detecting comprises detecting a residual phase by applying the variable to a relational formula between a random phase offset of the carrier frequency and a phase offset of a reference frequency that is generated when signals having the carrier frequency is transmitted.

16. The method of claim 15, wherein the detecting further comprises detecting the residual phase by excluding the random phase offset from the relational formula when the plurality of signals having the same carrier frequency is simultaneously transmitted from the same terminal.

17. The method of claim 11, wherein the recognizing comprises expressing a distance from the terminal through the difference between the first residual phase and the second residual phase, and recognizing the location of the terminal using a distance having a relatively maximum value from the expressed distance.

18. The method of claim 11, wherein the recognizing comprises recognizing the location of the terminal when the difference between the first residual phase and the second residual phase is less than a periodic value of the carrier frequency.

19. The method of claim 11, wherein the recognizing comprises recognizing the location of the terminal by further using a distance between terminals when the plurality of signals is received from the different terminals.

20. The method of claim 11, further comprising:
receiving the plurality of signals using a television white space (TVWS) frequency.
